(19) United States
(12) Patent Application Publication
(10) Pub. No.: US 2005/0102114 A1
(43) Pub. Date: May 12, 2005

(54) System and method for determining processor utilization

(75) Inventor: Raju Yasala, Santa Clara, CA (US)

Correspondence Address: MARSHALL, GERSTEIN & BORUN LLP, 6300 SEARS TOWER, 233 S. WACKER DRIVE, CHICAGO, IL, 60606, US

(73) Assignee: INTEL CORPORATION, Santa Clara, CA (US)

(21) Appl. No.: 10/706,195

(22) Filed: Nov. 12, 2003

(51) Int. Cl. G06F 19/00

(52) U.S. Cl. 702/65

(57) ABSTRACT

A system and method to determine utilization of a processor is disclosed. A power line provides power to the processor. A sensor is coupled to the power line for measuring real-time current being consumed by the processor. The real-time current is compared to a maximum current value.

### FIELD OF THE INVENTION

This invention relates generally to using processor current consumption data to determine processor utilization, and more specifically, to a system and method for determining processor utilization without compromising performance of the processor.

### BACKGROUND OF THE INVENTION

A computer processor has a finite number of instructions it can process per unit of time. Complex processor instructions require more processor resources per unit of time as compared to simple processor instructions. When the computer processor reaches its limit of instruction processing capability, software applications running on that processor take longer to complete. The amount of processor resources being used by the processor is known as processor utilization and is usually displayed as a percentage (e.g. 50% utilization).

In the past, determining processor utilization was accomplished by a utilization software program (utilization application) running on the same processor of which utilization information was desired. This arrangement had two significant drawbacks. First, the utilization application added additional overhead to the processor and resulted in the processor's performance being compromised. Running the utilization application on the same processor for which utilization information is desired results in an inability to differentiate the amount of resources consumed by the utilization application versus other applications running on the processor.

Second, the utilization information provided by the utilization application reflected a time value in which software applications were being executed by the processor. This value was indicative of how much time a processor spent on a software application rather than an indication of the amount of processor resources being used by the processor. As a result, a high value for processor utilization was not necessarily indicative of the amount of resources the processor was using, but merely indicated a software application consuming a large part of the processor's time.

### BRIEF DESCRIPTION OF THE DRAWINGS

FIG. 1 is a block diagram of a system in accordance with the invention.

FIG. 2 is a plot of percent processor utilization versus time for various revisions of a software application executed by the target processor, in accordance with one embodiment of the invention.

FIG. 3 is a flowchart illustrating steps of obtaining data indicative of processor utilization from the target processor, in accordance with the invention.

### DETAILED DESCRIPTION OF THE INVENTION

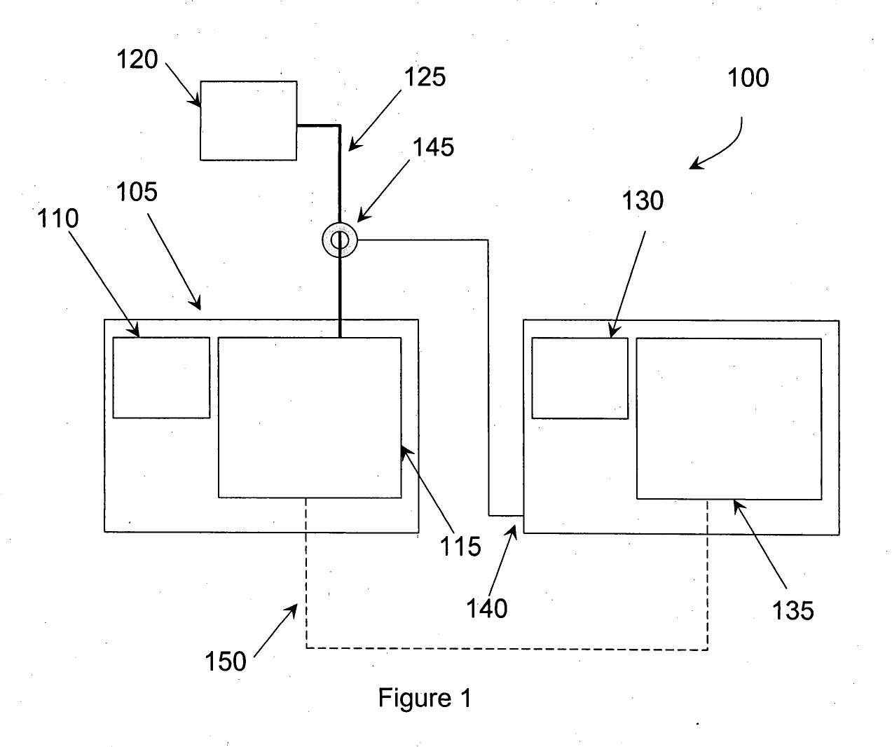

A system 100 for determining processor utilization in a target computer system 105 is illustrated in FIG. 1. The target computer system 105 has a memory 110 and a target computer processor 115 (hereinafter target processor) being supplied power from a power supply 120 through a power line 125. The system 100 has a memory 130, a processor 135, and an input 140.

In accordance with the invention, a current sensor 145, such as a hall-effect sensor, measures real-time current consumed by the target processor 115. The real-time current consumed by the target processor 115 is proportional to the utilization of the target processor 115. The real-time current is compared to a maximum current value, the maximum current value indicative of the current consumed by the target processor 115 when fully utilized, to determine the real-time percent utilization of the target processor 115. Control and/or communication between the system 100 and the target system 105 is accomplished with a control line 150.

A software application known as a utilization application controls the system 100 during data acquisition of the target system's processor 115. The utilization application is stored in the system memory 130 and executed by the system processor 135. Control of the system 100 includes collecting data from the current sensor 145, logging sensor data received at an input 140 to the system memory 130, controlling the number of samples collected per unit of time, calculating utilization data based on both the maximum current value and the data collected from the current sensor 145, and generating plots.

Calculation of processor utilization requires two pieces of data. The first piece of data is the real-time current being consumed by the target processor 115. The second piece of data is the current that the target processor 115 uses when it is 100% utilized.

The utilization application divides the value for real-time current used by the target processor 115 at any one moment by the value for maximum current that could be used by the target processor 115 to yield a percentage of processor utilization. The maximum current consumed by the target processor 115 is data that may be supplied by the target processor's manufacturer. However, for circumstances where the target processor's maximum current consumption is not known, a maximum current utility (software application) is used to cause the target processor 115 to utilize a maximum amount of the target processor's resources. The maximum current utility (MCU) is stored in the target system memory 110 and executed by the target processor 115 after being initiated by the utilization application via the control line 150. During execution of the MCU for a pre-determined amount of time, the current sensor 145 measures the current used by the target processor 115 and sends that current data to the system input 140 where the utilization application stores it to the memory 130 for later use in the processor utilization calculation. An average maximum current is calculated by the utilization application and is considered a “benchmark” of the target processor 115 for which all real-time activity is compared.

Data representative of average maximum current, determined by executing the MCU for a pre-determined amount of time at an earlier stage, is performed on the processor 115 at least once. This maximum current benchmark may be determined on an assembly line after manufacturing, or after the processor is installed in a computer system. For example, if the MCU determines the average maximum current to be 75 units, any subsequent current reading is divided by the maximum current value to compute the processor utilization. Thus, a real-time current measurement of 30 units would yield a processor utilization value of 40%.

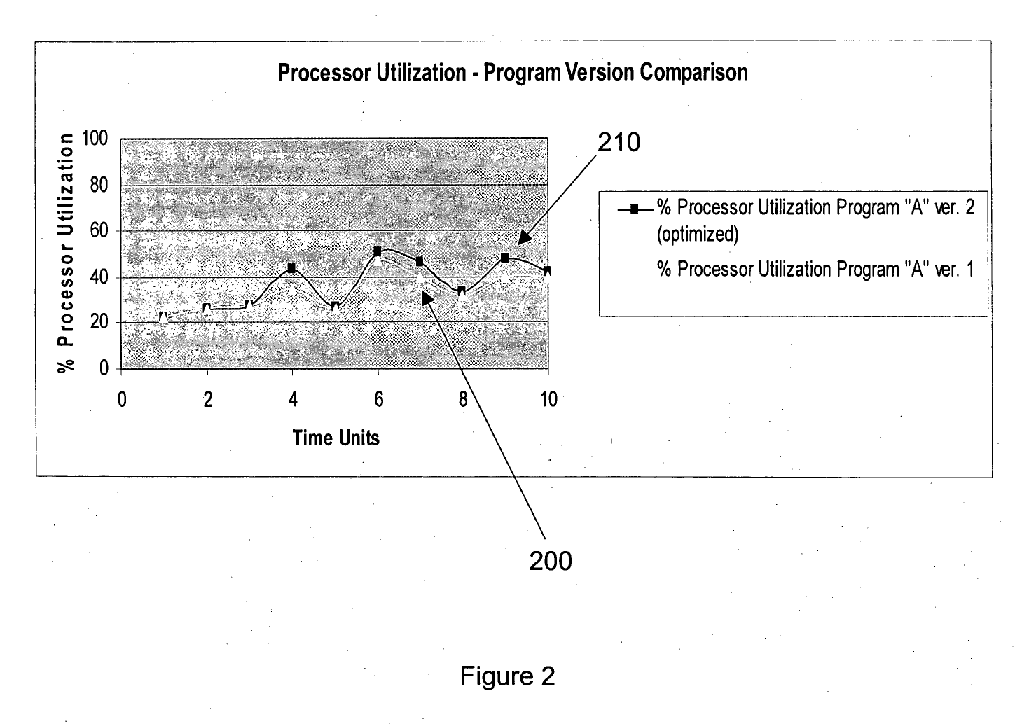

Target system performance bottlenecks may be discovered and software architects will find processor utilization data useful during application tuning to verify performance effects among various software application versions, as shown in FIG. 2. Data associated with program A.1 (version 1 of program A) 200 displays significant processor utilization values at time units 4, 6, and 9. After the software architect modifies program A.1 (thereby creating version A.2) to utilize more processor resources at those times, the system 100 may be used to compare program A.1 200 with the optimized program A.2 210. The system 100 plots data for both programs A.1 200 and A.2 210 to allow the system architect to verify whether or not program A.2 210 is an improvement over the previous version. FIG. 2 illustrates that the efforts of the software architect were successful such that optimized program A.2 210 has a higher processor utilization value at time units 4, 6, and 9 than previous version A.1 200. As such, target system performance bottlenecks may be reduced by using more processor resources.

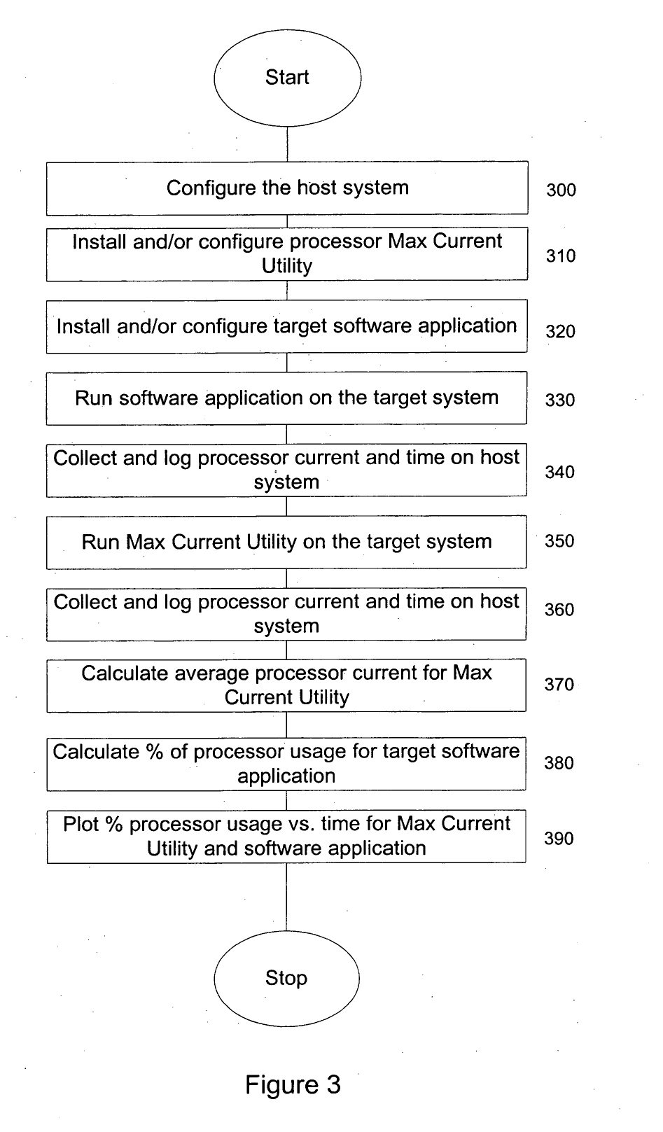

FIG. 3 illustrates steps of a method for determining processor utilization. Beginning at block 300, the host system 100 is configured. Configuration of the host system 100 includes connecting the current sensor 145 to the target processor 115 and adjusting user settings. One sample configuration collects processor utilization data and generates comparative plots, as shown in FIG. 2, whereas other sample configurations may collect and plot processor utilization in real-time. At block 310 the MCU is installed on the target processor 115 for circumstances where a target processor's maximum current consumption is unknown. As discussed earlier, the MCU is a software application adapted to utilize a maximum amount of processor resources on the target processor. Measuring the current consumed by the processor when it is most utilized allows a benchmark to be established so that processor utilization is calculated as a ratio of the target processor's 115 maximum capabilities. Block 320 involves setting up a target software application on the target system 105 wherein the software application's demand on the target processor 115 is unknown. More than one target software application may be installed/configured on the target system 105 to ascertain how utilized the target processor 115 is during the execution of those software applications. The target application is started for a pre-determined amount of time at block 330 and the effects of that application on the target processor 115 are collected by the current sensor 145 and logged at block 340. After the target software application has stopped executing, the MCU is started at block 350 and the effects of the MCU on the target processor 115 are collected by the current sensor 145 and logged at block 360. Upon completion of data collection at block 360, an average maximum processor current value is calculated at block 370. The host system 100 now has enough data at block 380 to calculate the percentage of processor usage caused by executing the target application(s). The percent of processor utilization is obtained by dividing the current consumed by the target processor 115 during execution of the software application(s) by the average maximum processor current consumed when the MCU was executed. The host system 100 plots the percent processor usage versus time at block 390.

Although the foregoing text sets forth a detailed description of numerous different embodiments of a system and method for determining processor utilization, it should be understood that the legal scope of the method and apparatus is defined by the words of the claims set forth at the end of this patent. The detailed description is to be construed as exemplary only and does not describe every possible embodiment of the system and method for determining processor utilization because describing every possible embodiment would be impractical, if not impossible. Numerous alternative embodiments could be implemented, using either current technology or technology developed after the filing date of this patent, which would still fall within the scope of the claims defining the system and method for determining processor utilization.

Thus, many modifications and variations may be made in the techniques and structures described and illustrated herein without departing from the spirit and scope of the present invention. Accordingly, it should be understood that the methods and apparatuses described herein are illustrative only and are not limiting upon the scope of the system and method for determining processor utilization.

1. For a processor having a power line, a system to determine processor utilization, the system comprising:
a sensor coupled to the power line for measuring current being consumed by the processor.

2. The system of claim 1, wherein the measured current is compared to a maximum current value indicative of current consumed by the processor when fully utilized.

3. The system of claim 1, wherein the system includes means for determining a maximum current value indicative of current consumed by the processor when fully utilized.

4. The system of claim 3, wherein the means for determining the maximum current value includes a software application.

5. The system of claim 1, wherein the system includes means for causing the processor to be fully utilized.

6. The system of claim 5, wherein the means for causing the processor to be fully utilized includes a software application.

7. The system of claim 2, wherein the system includes means for comparing the measured current to the maximum current value.

8. The system of claim 7, wherein the means for comparing includes a software application executed by the system.

9. The system of claim 1, wherein the system includes means for generating a graphical representation of processor utilization.

10. The system of claim 9, wherein the means for generating the graphical representation includes a software application executed by the system.

11. A method for determining processor utilization information comprising:
acquiring a parameter indicative of current being consumed by the processor;
comparing the acquired parameter to a maximum current value; and
calculating the utilization information of the processor.

12. The method of claim 11, wherein the step of acquiring the parameter includes utilizing a sensor to sense the current parameter.

13. The method of claim 11, including causing the processor to be fully utilized.

14. The method of claim 13, including determining a maximum parameter indicative of a maximum current consumed by the processor.

15. The method of claim 13, including utilizing a software application to fully utilize the processor.

16. The method of claim 11, including graphically displaying the utilization information.

17. The method of claim 12, wherein the sensor is a hall-effect sensor.

18. For a target processor including a power line, a system to determine target processor utilization comprising:
a host including a host memory, and a host processor;
a sensor coupled to the power line adapted to measure the magnitude of current being consumed by the target processor;
a maximum current utility adapted to cause the target processor to consume a maximum amount of current by the target processor; and
a utilization utility adapted to be stored in the host memory and executed by the host processor, the utilization utility further adapted to calculate utilization information of the target processor.

19. The system of claim 18, wherein the utilization utility is adapted to graphically display the calculated utilization information.

20. A method for determining utilization information of a target processor comprising:
acquiring a parameter indicative of current being consumed by the target processor while executing a software application;
fully utilizing the target processor;
acquiring a parameter indicative of maximum current consumed by the target processor while the target processor is fully utilized; and
comparing the parameters indicative of current consumed by the target processor with the maximum current consumed by the target processor to calculate target processor utilization information.

21. The method of claim 20, including optimization of the software application in response to the calculated target processor utilization information.

22. A system to determine processor utilization, comprising:
a processor having a power line; and
a sensor coupled to the power line to measure current in the power line.

23. The system of claim 22, wherein the measured current is compared to a maximum current value indicative of current consumed by the processor when fully utilized.

24. The system of claim 23, wherein the system includes a software application for determining the maximum current value.
